(19) United States
(12) Patent Application Publication
(10) Pub. No.: US 2018/0008013 A1
(43) Pub. Date: Jan. 11, 2018

(54) ZIPPER HEAD ASSEMBLY STRUCTURE AND SLIDING ELEMENT THEREOF

(71) Applicant: CHUNG CHWAN ENTERPRISE CO., LTD., Taoyuan City (TW)

(72) Inventor: YU-PAU LIN, TAOYUAN CITY (TW)

(21) Appl. No.: 15/295,658

(22) Filed: Oct. 17, 2016

(30) Foreign Application Priority Data
Jul. 6, 2016 (TW) 105210179

(51) Int. Cl. A44B 19/64; F16B 1/04; A44B 19/26

(52) U.S. Cl. CPC A44B 19/64; A44B 19/262; F16B 1/04

(57) ABSTRACT

The prevent invention provides a zipper head assembly structure and a slidable element thereof. The sliding element has a base portion, two lateral wall portions, and a seat portion. The base portion has a front side and a back side. The two lateral wall portions are respectively upwardly extended from two opposite lateral sides of the base portion, and the two lateral wall portions correspond to each other and are connected to the front side of the base portion. The seat portion is disposed on the base portion and connected to the back side of the base portion. The seat portion has a main body disposed on the base portion and connected to the back side of the base portion, two strip convex ribs respectively disposed on two opposite sides of the main body, and two concave spaces respectively connected to the two strip convex ribs.

### BACKGROUND OF THE INVENTION

### 1. Field of the Invention

The instant disclosure relates to a zipper head assembly structure and a sliding element thereof, and more particularly to a zipper head assembly structure and a sliding element thereof for increasing production yield and decreasing manufacturing cost.

### 2. Description of Related Art

In general, zippers are basic elements in clothing or accessories. Compared to buttons, zippers are easier to use. A conventional zipper comprises a zipper head and a tape. The zipper head works with the tape to allow the pulling action. The zipper has been used commonly for clothing, pants, backpack, and other accessories.

### SUMMARY OF THE INVENTION

One aspect of the instant disclosure relates to a zipper head assembly structure and a sliding element thereof for increasing production yield and decreasing manufacturing cost.

One of the embodiments of the instant disclosure provides a zipper head assembly structure, comprising: a sliding element, a retaining element, and a pulling element. The sliding element has a base portion, two lateral wall portions, and a seat portion, the two lateral wall portions are respectively upwardly extended from two opposite lateral sides of the base portion, the two lateral wall portions correspond to each other and connected to a front side of the base portion, the seat portion is disposed on the base portion and connected to a back side of the base portion, the seat portion has a positioning passing hole formed between the two lateral wall portions, and the seat portion has a main body disposed on the base portion and connected to the back side of the base portion, two strip convex ribs respectively disposed on two opposite sides of the main body, and two concave spaces respectively connected to the two strip convex ribs. The retaining element is movably disposed on the seat portion, and the retaining element has a positioning portion disposed on an end portion thereof and passing through the positioning passing hole. The pulling element is movably mated with the retaining element.

Another one of the embodiments of the instant disclosure provides a sliding element, comprising: a base portion, two lateral wall portions, and a seat portion. The base portion has a front side and a back side. The two lateral wall portions are respectively upwardly extended from two opposite lateral sides of the base portion, and the two lateral wall portions correspond to each other and are connected to the front side of the base portion. The seat portion is disposed on the base portion and connected to the back side of the base portion. The seat portion has a main body disposed on the base portion and connected to the back side of the base portion, two strip convex ribs respectively disposed on two opposite sides of the main body, and two concave spaces respectively connected to the two strip convex ribs.

Yet another one of the embodiments of the instant disclosure provides a sliding element, comprising: a base portion, two lateral wall portions, and a seat portion, the two lateral wall portions respectively upwardly extended from two opposite lateral sides of the base portion, the two lateral wall portions corresponding to each other, and the seat portion disposed on the base portion. The seat portion has a main body disposed on the base portion and connected to the back side of the base portion, two strip convex ribs respectively disposed on two opposite sides of the main body, and two concave spaces respectively connected to the two strip convex ribs.

Therefore, the seat portion has a main body disposed on the base portion and connected to the back side of the base portion, two strip convex ribs respectively disposed on two opposite sides of the main body, and two concave spaces respectively connected to the two strip convex ribs, so that the production yield of the sliding element can be increased and the manufacturing cost of the sliding element can be decreased due to the seat portion with the two strip convex ribs and the two concave spaces.

To further understand the techniques, means and effects of the instant disclosure, the following detailed descriptions and appended drawings are hereby referred to, such that, and through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

The accompanying drawings are included to provide a further understanding of the instant disclosure, and are incorporated in and constitute a part of this specification. The drawings illustrate exemplary embodiments of the instant disclosure and, together with the description, serve to explain the principles of the instant disclosure.

FIG. 1 shows a perspective, schematic view of the first mold core structure according to the instant disclosure;

FIG. 2 shows another perspective, schematic view of the first mold core structure according to the instant disclosure;

FIG. 3 shows a perspective, schematic view of the second mold core structure according to the instant disclosure;

FIG. 4 shows another perspective, schematic view of the second mold core structure according to the instant disclosure;

FIG. 5 shows a perspective, assembly, schematic view of the first mold core structure mated with the second mold core structure according to the instant disclosure;

FIG. 6 shows a cross-sectional view taken along the section line VI-VI of FIG. 5;

FIG. 7 shows a cross-sectional view taken along the section line VII-VII of FIG. 5;

FIG. 8 shows a perspective, exploded, schematic view of the first mold core structure and the second mold core structure according to the instant disclosure;

FIG. 9 shows a lateral, schematic view of the sliding element according to the instant disclosure;

FIG. 10 shows another lateral, schematic view of the sliding element according to the instant disclosure;

FIG. 11 shows a rear, schematic view of the sliding element according to the instant disclosure;

FIG. 12 shows a perspective, assembly, schematic view of the zipper head assembly structure according to the instant disclosure;

FIG. 13 shows a schematic view of the shape of the main body and the strip rib formed by matching two first extending portions and two second extending portions according to the instant disclosure;

FIG. 14 shows a schematic view of the shape of the main body and the strip rib formed by matching a first extending portion and a second extending portion according to an embodiment of the instant disclosure;

FIG. 15 shows a schematic view of the shape of the main body and the strip rib formed by matching a first extending portion and a second extending portion according to another embodiment of the instant disclosure; and

FIG. 16 shows a schematic view of the shape of the main body and the strip rib formed by matching a first extending portion and a second extending portion according to yet another embodiment of the instant disclosure.

### DETAILED DESCRIPTION OF THE PREFERRED EMBODIMENTS

The embodiments of a zipper head assembly structure and a sliding element thereof of the instant disclosure are described. Other advantages and objectives of the instant disclosure can be easily understood by one skilled in the art from the disclosure. The instant disclosure can be applied in different embodiments. Various modifications and variations can be made to various details in the description for different applications without departing from the scope of the instant disclosure. The drawings of the instant disclosure are provided only for simple illustrations, but are not drawn to scale and do not reflect the actual relative dimensions. The following embodiments are provided to describe in detail the concept of the instant disclosure, and are not intended to limit the scope thereof in any way.

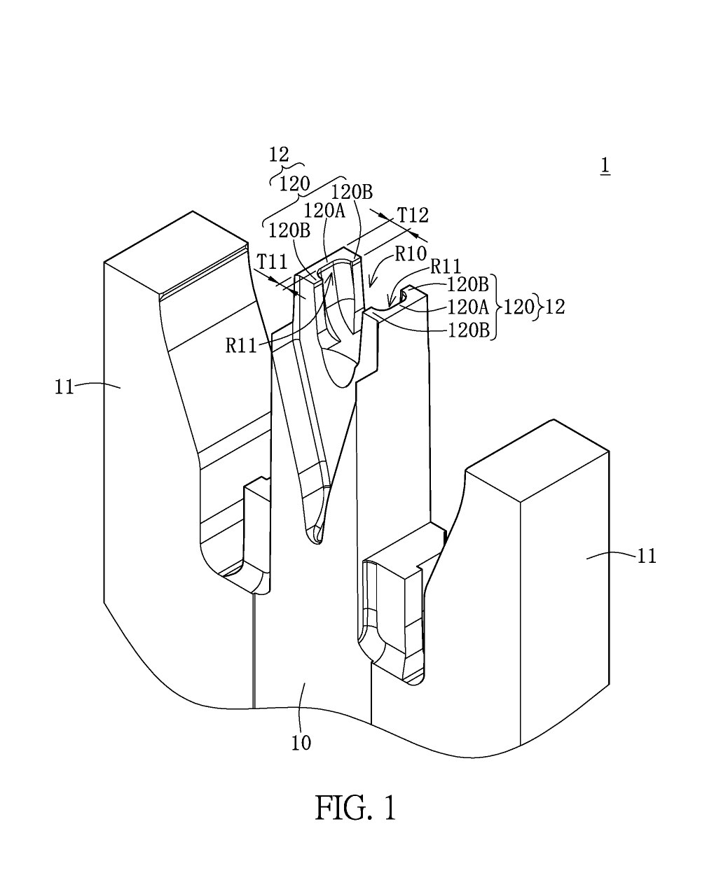

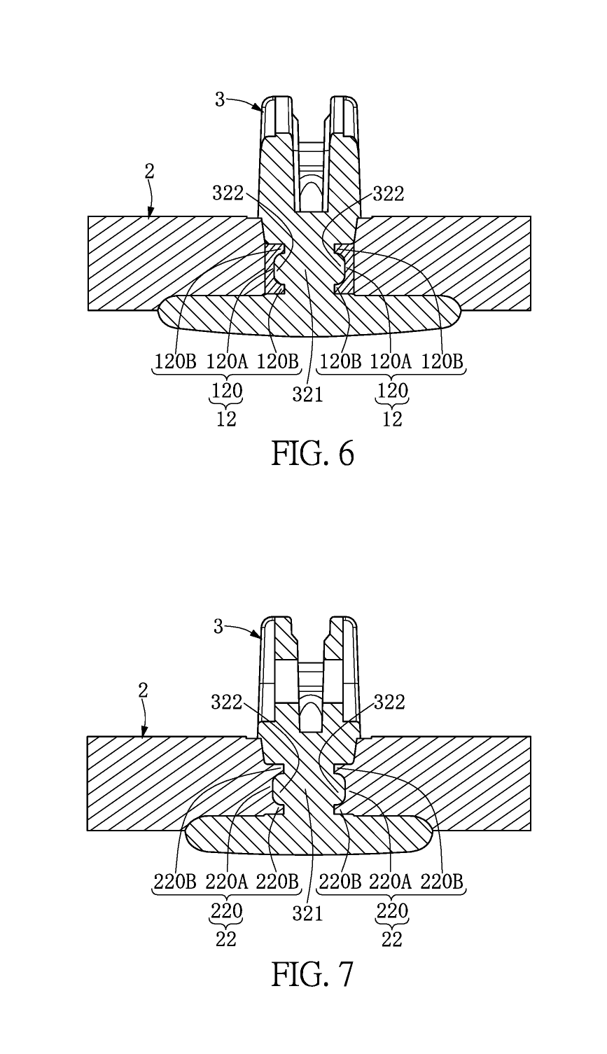

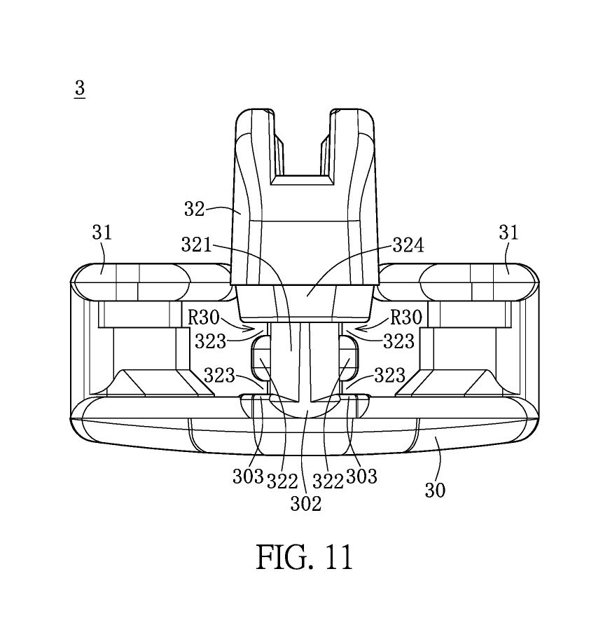

Referring to FIG. 1 to FIG. 11, the instant disclosure provides a mold core assembly M for forming a partial shape of a sliding element 3 of a zipper head assembly structure Z. The sliding element 3 has a base portion 30, two lateral wall portions 31, and a seat portion 32. The two lateral wall portions 31 are respectively upwardly extended from two opposite lateral sides of the base portion 30, the two lateral wall portions 31 correspond to each other and are connected to a front side 301 of the base portion 30, and the seat portion 32 is disposed on the base portion 30 and connected to a back side 302 of the base portion 30. In addition, the seat portion 32 has a main body 321 disposed on the base portion 30 and connected to the back side 302 of the base portion 30, two strip convex ribs 322 respectively disposed on two opposite sides of the main body 321, and two concave spaces 323 respectively connected to the two strip convex ribs 322 and respectively partially surrounds the two strip convex ribs 322.

Referring to FIG. 1 to FIG. 8, the mold core assembly M includes a first mold core structure 1 and a second mold core structure 2.

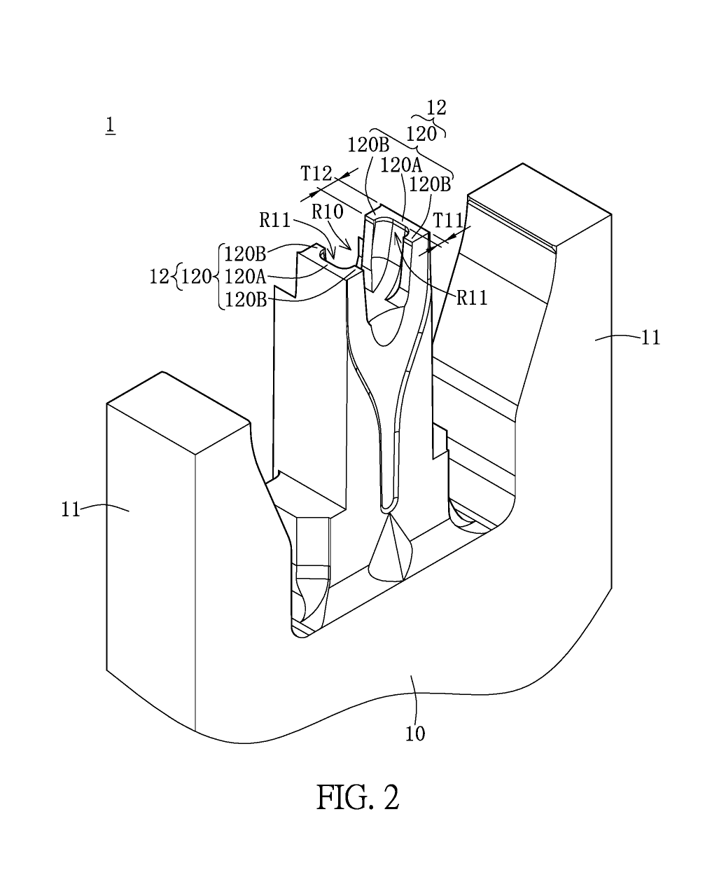

First, referring to FIG. 1 and FIG. 2, the first mold core structure 1 has a first base body 10, two first lateral structure bodies 11 extended from the first base body 10 and opposite to each other, and a first middle structure body 12 extended from the first base body 10 and disposed between the two first lateral structure bodies 11. In addition, the first middle structure body 12 has two first extending portions 120 opposite to each other, and each first extending portion 120 has a first basis portion 120A and two first thickening portions 120B inwardly projected from the first basis portion 120A. Therefore, the structural strength of the first extending portion 120 can be increased due to the two corresponding first thickening portions 120B, so that the usage life of the mold core assembly M can be increased, and the production yield of the sliding element 3 can be increased and the manufacturing cost of the sliding element 3 can be decreased.

Following the above description, the two first thickening portions 120B of one of the two first extending portions 120 respectively face the two first thickening portions 120B of another one of the two first extending portions 120. In addition, the first basis portion 120A has a first basis thickness T11, the first thickening portion 120B has a first thickening thickness T12, and the first thickening thickness T12 of the first thickening portion 120B is larger than the first basis thickness T11 of the first basis portion 120A. That is to say, each first extending portion 120 has a nonuniform thickness. Moreover, the first middle structure body 12 has a first major receiving space R10 formed between the two first extending portions 120, each first extending portion 120 has a first minor receiving space R11 formed between the two corresponding first thickening portions 120B, and the first major receiving space R10 is communicated between the two first minor receiving spaces R11 of the two first extending portions 120.

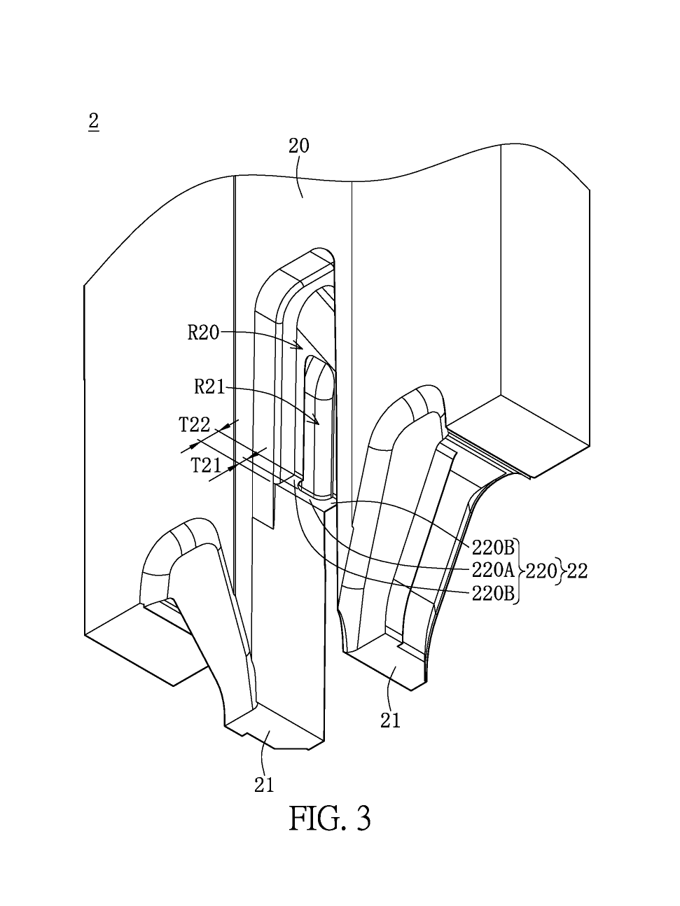

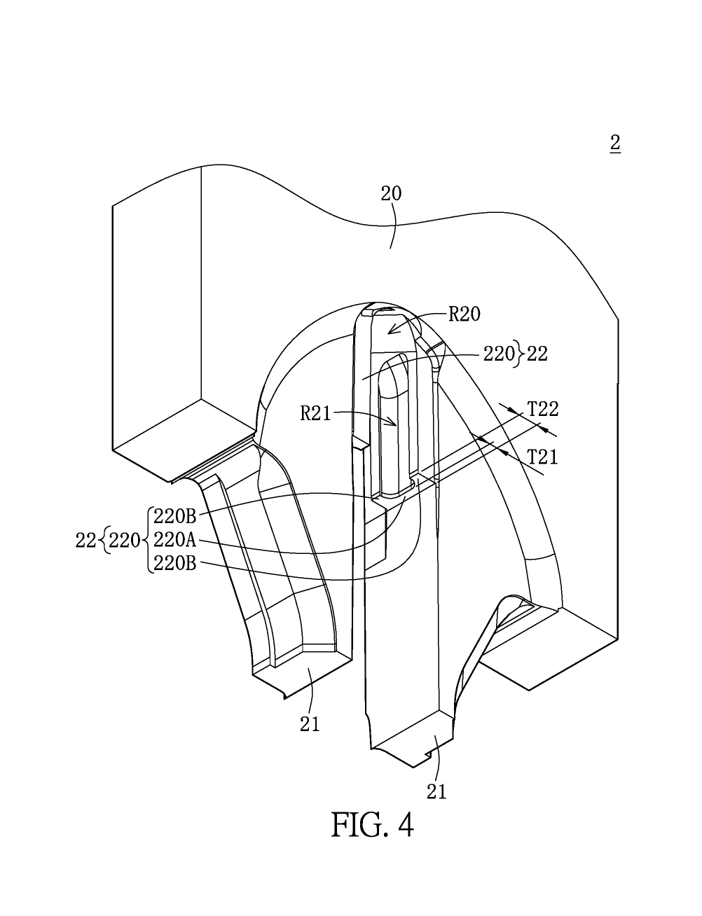

Furthermore, referring to FIG. 3 and FIG. 4, the second mold core structure 2 has a second base body 20, two second lateral structure bodies 21 extended from the second base body 20 and opposite to each other, and a second middle structure body 22 extended from the second base body 20 and disposed between the two second lateral structure bodies 21. In addition, the second middle structure body 22 has two second extending portions 220 opposite to each other, and each second extending portion 220 has a second basis portion 220A and two second thickening portions 220B inwardly projected from the second basis portion 220A. Therefore, the structural strength of the second extending portion 220 can be increased due to the two corresponding second thickening portions 220B, so that the usage life of the mold core assembly M can be increased, and the production yield of the sliding element 3 can be increased and the manufacturing cost of the sliding element 3 can be decreased.

Following the above description, the two second thickening portions 220B of one of the two second extending portions 220 respectively face the two second thickening portions 220B of another one of the two second extending portions 220. In addition, the second basis portion 220A has a second basis thickness T21, the second thickening portion 220B has a second thickening thickness T22, and the second thickening thickness T22 of the second thickening portion 220B is larger than the second basis thickness T21 of the second basis portion 220A. That is to say, each second extending portion 220 has a nonuniform thickness. Furthermore, the second middle structure body 22 has a second major receiving space R20 formed between the two second extending portions 220, each second extending portion 220 has a second minor receiving space R21 formed between the two corresponding second thickening portions 220B, the second major receiving space R20 is communicated with the first major receiving space R10 and communicated between the two second minor receiving spaces R21 of the two second extending portions 220, and the two second minor receiving spaces R21 of the two second extending portions 220 are respectively communicated with the two first minor receiving spaces R11 of the two first extending portions 120.

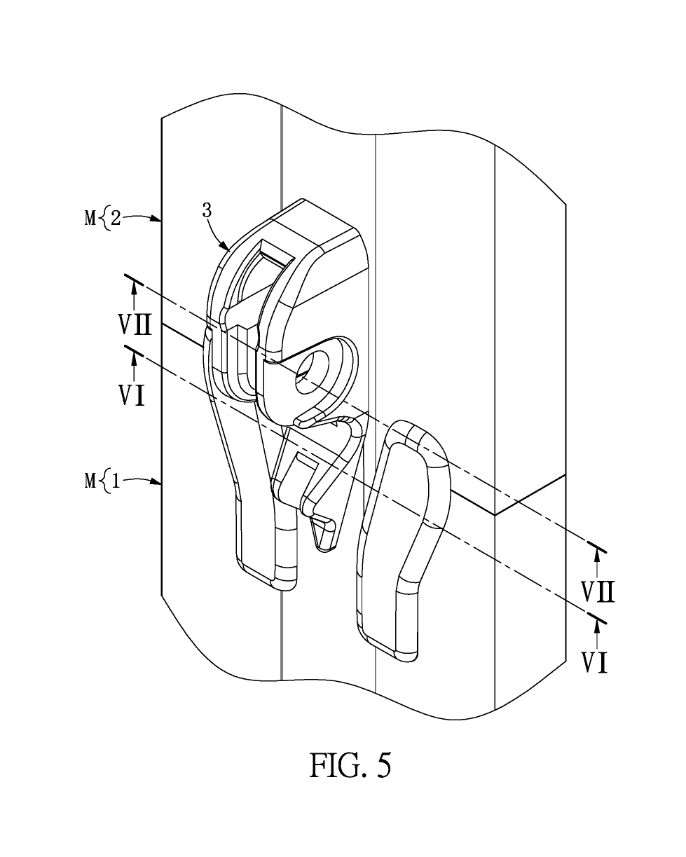

Furthermore, referring to FIG. 1, FIG. 3, and FIG. 5 to FIG. 8, the two first extending portions 120 of the first middle structure body 12 are respectively connected to the two second extending portions 220 of the second middle structure body 22, and a partial shape of the seat portion 32 can be formed by matching the two first extending portions 120 of the first middle structure body 12 of the first mold core structure 1 and the two second extending portions 220 of the second middle structure body 22 of the second mold core structure 2.

More particularly, the main body 321 of the seat portion 32 can correspond to the first major receiving space R10 and the second major receiving space R20, so that the shape of the main body 321 of the seat portion 32 can be formed by matching the first major receiving space R10 and the second major receiving space R20.

More particularly, each strip convex rib 322 can correspond to the first minor receiving space R11 of the corresponding first extending portion 120 and the second minor receiving space R21 of the corresponding second extending portion 220, so that the shape of each strip convex rib 322 can be formed by matching the first minor receiving space R11 of the corresponding first extending portion 120 and the second minor receiving space R21 of the corresponding second extending portion 220.

More particularly, each concave space 323 can correspond to the two first thickening portions 120B of the corresponding first extending portion 120 and the two second thickening portions 220B of the corresponding second extending portion 220, so that the shape of each concave space 323 can be formed by matching the two first thickening portions 120B of the corresponding first extending portion 120 and the two second thickening portions 220B of the corresponding second extending portion 220.

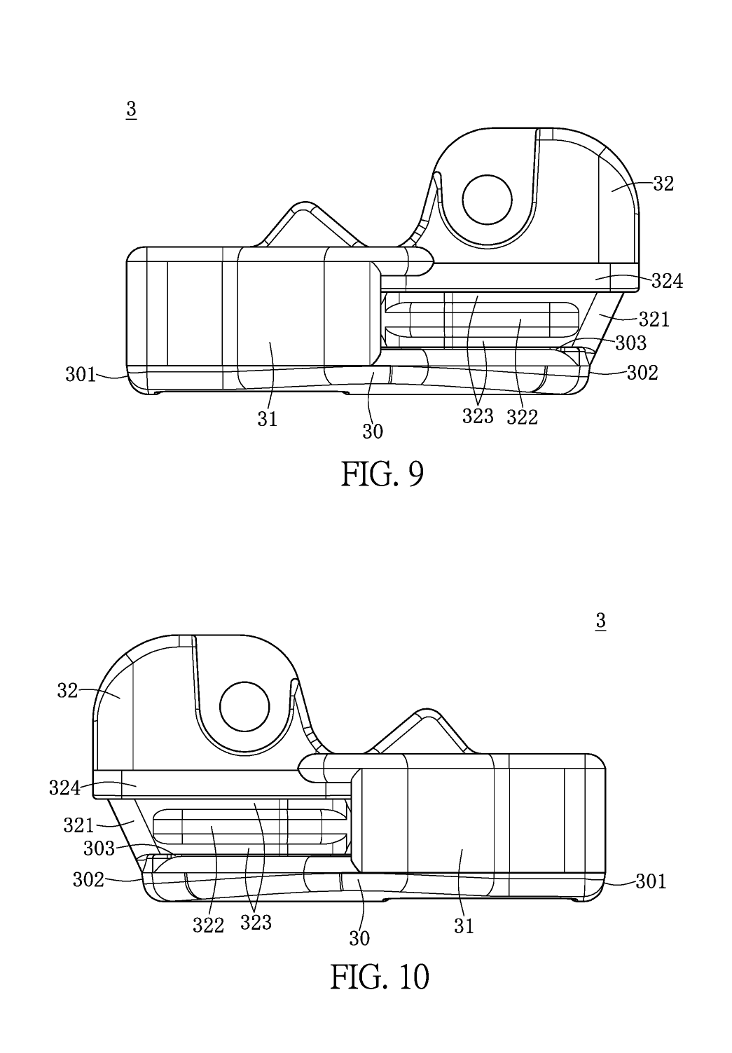

Therefore, referring to FIG. 9 to FIG. 12, the instant disclosure provides a zipper head assembly structure Z, comprising: a sliding element 3 (such as a sliding head, or a slide fastener head), a retaining element 4 (such as a hook body or a horse-like hook), and a pulling element 5 (such as a pull tab or a pull piece).

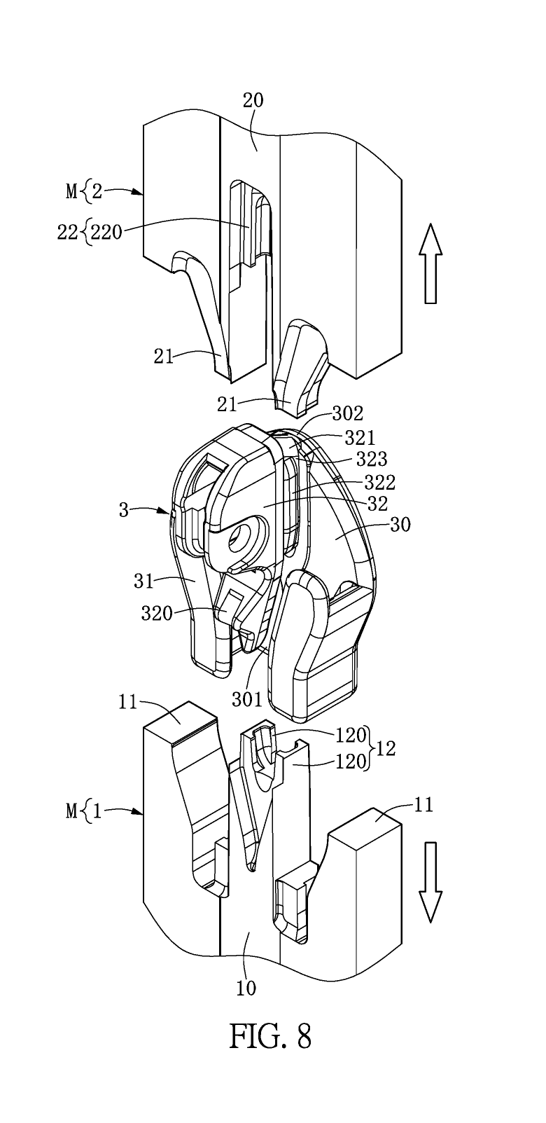

First, referring to FIG. 9 to FIG. 11, the sliding element 3 has a base portion 30, two lateral wall portions 31, and a seat portion 32. The two lateral wall portions 31 are respectively upwardly extended from two opposite lateral sides of the base portion 30, and the two lateral wall portions 31 correspond to each other and are connected to a front side 301 of the base portion 30. In addition, the seat portion 32 is disposed on the base portion 30 and connected to a back side 302 of the base portion 30, and the seat portion 32 has a positioning passing hole 320 formed between the two lateral wall portions 31 as shown in FIG. 8. Moreover, the seat portion 32 has a main body 321 disposed on the base portion 30 and connected to the back side 302 of the base portion 30, two strip convex ribs 322 respectively disposed on two opposite sides of the main body 321, and two concave spaces 323 respectively connected to the two strip convex ribs 322. Please note, the two concave spaces 323 are respectively concaved from two opposite sides of the main body 321, so that the metal material used for forming the shape of the seat portion 32 can be reduced so as to reduce the manufacturing cost of the sliding element 3.

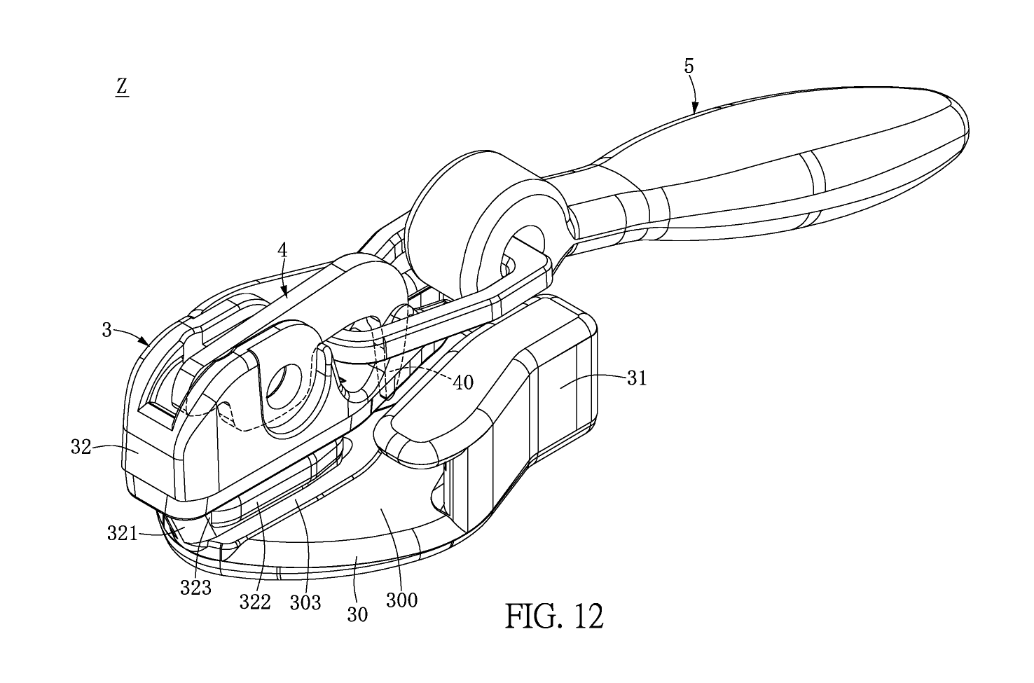

Moreover, referring to FIG. 8 and FIG. 12, the retaining element 4 is movably disposed on the seat portion 32, and the retaining element 4 has a positioning portion 40 disposed on an end portion thereof and passing through the positioning passing hole 320. In addition, the pulling element 5 is movably mated with the retaining element 4.

More particularly, referring to FIG. 9 to FIG. 11, the base portion 30 of the sliding element 3 has a micro protrusion 303 projected from an inner surface 300 thereof, the micro protrusion 303 is connected to the main body 321 of the seat portion 32 and partially surrounds the main body 321 of the seat portion 32, and the two concave spaces of the seat portion and the micro protrusion of the base portion are formed into U shapes. In addition, the seat portion 32 has a carrier 324 disposed on the main body 321 and separated from the base portion 30 and two recess spaces R30 formed between the micro protrusion 303 and the carrier 324, the two recess spaces R30 are respectively communicated with the two concave spaces 323, and the two strip convex ribs 322 are respectively totally received in the two recess spaces R30.

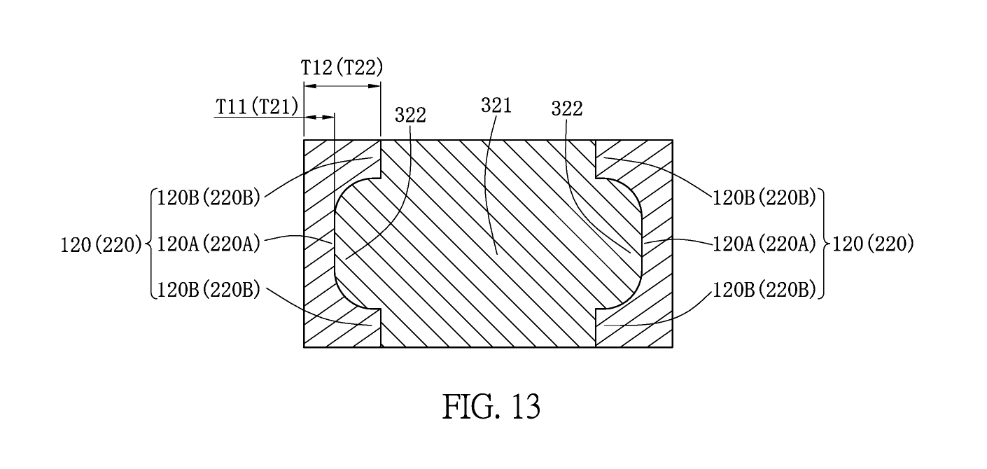

In conclusion, referring to FIG. 13, the shape of the main body 321 of the seat portion 32 and the shape of each strip convex rib 322 can be formed by matching the two first extending portions 120 of the first middle structure body 12 of the first mold core structure 1 and the two second extending portions 220 of the second middle structure body 22 of the second mold core structure 2. With regard to the first mold core structure 1, each first extending portion 120 has a first basis portion 120A and two first thickening portions 120B, and the first thickening thickness T12 of the first thickening portion 120B is larger than the first basis thickness T11 of the first basis portion 120A. With regard to the second mold core structure 2, each second extending portion 220 has a second basis portion 220A and two second thickening portions 220B, and the second thickening thickness T22 of the second thickening portion 220B is larger than the second basis thickness T21 of the second basis portion 220A. Therefore, the structural strength of the first extending portion 120 and the second extending portion 220 can be increased due to the two corresponding first thickening portions 120B and the two corresponding second thickening portions 220B, so that the usage life of the mold core assembly M can be increased, and the production yield of the sliding element 3 can be increased and the manufacturing cost of the sliding element 3 can be decreased.

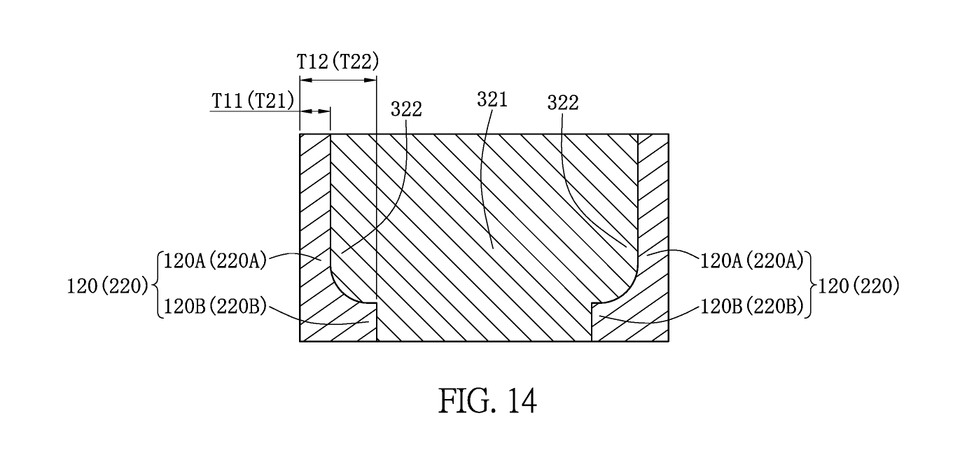

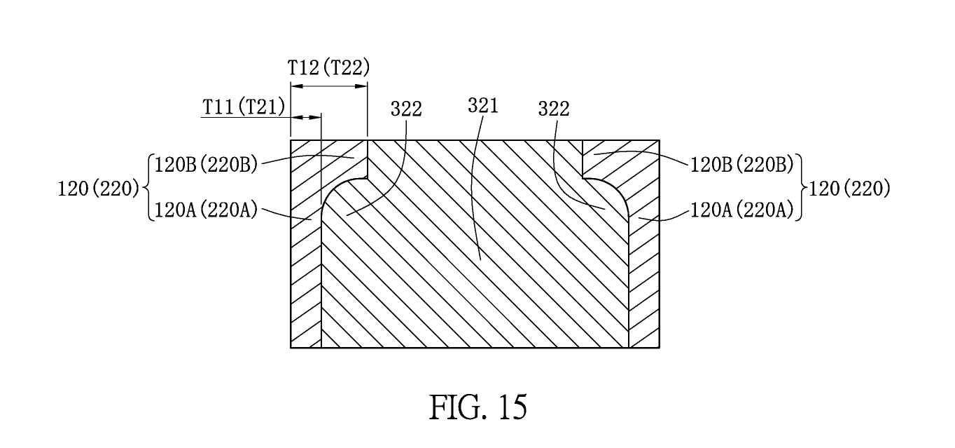

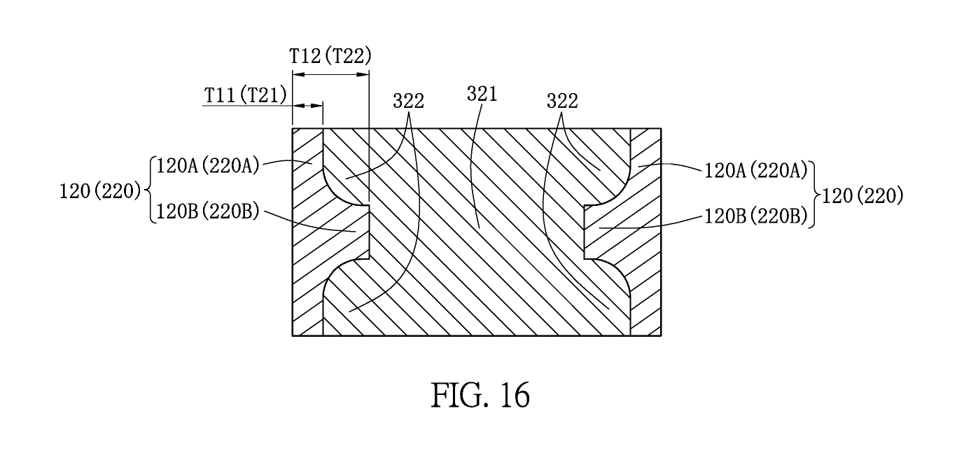

More particularly, referring to FIG. 14 to FIG. 16, the different from FIG. 14 (or FIG. 15, or FIG. 16) to FIG. 13 is as follows: referring to FIG. 14 to FIG. 16, each first extending portion 120 has a first basis portion 120A and at least one first thickening portion 120B inwardly projected from the first basis portion 120A, and each second extending portion 220 has a second basis portion 220A and at least one second thickening portion 220B inwardly projected from the second basis portion 220A. In addition, the at least one first thickening portion 120B of one of the two first extending portions 120 faces the at least one first thickening portion 120B of another one of the two first extending portions 120, and the at least one second thickening portion 220B of one of the two second extending portions 220 faces the at least one second thickening portion 220B of another one of the two second extending portions 222. That is to say, one embodiment of the instant disclosure can use only a first thickening portion 120B inwardly projected from the outermost portion (as shown in FIG. 14 and FIG. 15) or the middle portion (as shown in FIG. 16) of the first basis portion 120A, and use only a second thickening portion 220B inwardly projected from the outermost portion (as shown in FIG. 14 and FIG. 15) or the middle portion (as shown in FIG. 16) of the second basis portion 220A.

In conclusion, the seat portion 32 has a main body 321 disposed on the base portion 30 and connected to the back side 302 of the base portion 30, two strip convex ribs 322 respectively disposed on two opposite sides of the main body 321, and two concave spaces 323 respectively connected to the two strip convex ribs 322, so that the production yield of the sliding element 3 can be increased and the manufacturing cost of the sliding element 3 can be decreased due to the seat portion 32 with the two strip convex ribs 322 and the two concave spaces 323. More particularly, the structural strength of the first extending portion 120 and the second extending portion 220 can be increased due to the two corresponding first thickening portions 120B and the two corresponding second thickening portions 220B, so that the usage life of the mold core assembly M can be increased so as to increase the production yield of the sliding element 3 and decrease the manufacturing cost of the sliding element 3.

The aforementioned descriptions merely represent the preferred embodiments of the instant disclosure, without any intention to limit the scope of the instant disclosure which is fully described only within the following claims. Various equivalent changes, alterations or modifications based on the claims of the instant disclosure are all, consequently, viewed as being embraced by the scope of the instant disclosure.

What is claimed is:

1. A zipper head assembly structure, comprising:
a sliding element having a base portion, two lateral wall portions, and a seat portion, the two lateral wall portions respectively upwardly extended from two opposite lateral sides of the base portion, the two lateral wall portions corresponding to each other and connected to a front side of the base portion, the seat portion disposed on the base portion and connected to a back side of the base portion, the seat portion having a positioning passing hole formed between the two lateral wall portions, and the seat portion having a main body disposed on the base portion and connected to the back side of the base portion, two strip convex ribs respectively disposed on two opposite sides of the main body, and two concave spaces respectively connected to the two strip convex ribs;
a retaining element movably disposed on the seat portion, wherein the retaining element has a positioning portion disposed on an end portion thereof and passing through the positioning passing hole; and
a pulling element movably mated with the retaining element.

2. The zipper head assembly structure of claim 1, wherein the base portion has a micro protrusion projected from an inner surface thereof, the micro protrusion is connected to the main body of the seat portion and partially surrounding the main body of the seat portion, and the two concave spaces of the seat portion and the micro protrusion of the base portion are formed into U shapes.

3. The zipper head assembly structure of claim 2, wherein the seat portion has a carrier disposed on the main body and separated from the base portion and two recess spaces formed between the micro protrusion and the carrier, the two recess spaces are respectively communicated with the two concave spaces, and the two strip convex ribs are respectively totally received in the two recess spaces.

4. A sliding element, comprising:
a base portion having a front side and a back side;
two lateral wall portions respectively upwardly extended from two opposite lateral sides of the base portion, wherein the two lateral wall portions correspond to each other and are connected to the front side of the base portion; and
a seat portion disposed on the base portion and connected to the back side of the base portion;
wherein the seat portion has a main body disposed on the base portion and connected to the back side of the base portion, two strip convex ribs respectively disposed on two opposite sides of the main body, and two concave spaces respectively connected to the two strip convex ribs.

5. The sliding element of claim 4, wherein the base portion has a micro protrusion projected from an inner surface thereof, the micro protrusion is connected to the main body of the seat portion and partially surrounding the main body of the seat portion, and the two concave spaces of the seat portion and the micro protrusion of the base portion are formed into U shapes.

6. The sliding element of claim 5, wherein the seat portion has a carrier disposed on the main body and separated from the base portion and two recess spaces formed between the micro protrusion and the carrier, the two recess spaces are respectively communicated with the two concave spaces, and the two strip convex ribs are respectively totally received in the two recess spaces.

7. A sliding element, comprising: a base portion, two lateral wall portions, and a seat portion, the two lateral wall portions respectively upwardly extended from two opposite lateral sides of the base portion, the two lateral wall portions corresponding to each other, and the seat portion disposed on the base portion, wherein the seat portion has a main body disposed on the base portion and connected to the back side of the base portion, two strip convex ribs respectively disposed on two opposite sides of the main body, and two concave spaces respectively connected to the two strip convex ribs.

8. The sliding element of claim 7, wherein the base portion has a micro protrusion projected from an inner surface thereof, and the micro protrusion is connected to the main body of the seat portion and partially surrounding the main body of the seat portion.

9. The sliding element of claim 8, wherein the two concave spaces of the seat portion and the micro protrusion of the base portion are formed into U shapes.

10. The sliding element of claim 8, wherein the seat portion has a carrier disposed on the main body and separated from the base portion and two recess spaces formed between the micro protrusion and the carrier, the two recess spaces are respectively communicated with the two concave spaces, and the two strip convex ribs are respectively totally received in the two recess spaces.
